(19) United States
(12) Patent Application Publication
(10) Pub. No.: US 2015/0203688 A1
(43) Pub. Date: Jul. 23, 2015

(54) LIGHT CURABLE COLORED COATING

(71) Applicant: Chih-Hung CHUNG, Taipei City (TW)

(72) Inventor: Chih-Hung CHUNG, Taipei City (TW)

(21) Appl. No.: 14/597,572

(22) Filed: Jan. 15, 2015

(30) Foreign Application Priority Data
Jan. 23, 2014 (TW) 103102524

(51) Int. Cl. C09D 5/00; C09K 11/08

(52) U.S. Cl. CPC C09D 5/00; C09K 11/08

(57) ABSTRACT

The present invention provides a light curable colored coating, comprising a photoinitiator, a UV resin and a UV photosensitive phosphor, wherein the light curable colored coating is formed by mixing and then separating the photoinitiator, the UV resin and the UV photosensitive phosphor, wherein the mixture is applied to a substrate thereafter, and thus the curing time of the light curable colored coating is largely shortened.

### CROSS-REFERENCE TO RELATED APPLICATIONS

This application claims priority to Taiwan Patent Application No. 103102524 filed Jan. 23, 2104, the disclosure of which is incorporated herein in its entirety by reference.

### FIELD OF THE INVENTION

The present invention relates to colored coating, and more particularly to a light curable colored coating.

### BACKGROUND OF THE INVENTION

Coatings are widely applied to the surface of substrates such as electronic products, architectural materials, automobiles . . . etc, for the purpose of decoration and protection. However, the conventional coatings need repeated spraying process for evenly adhering the coating to the outer shell of electronic products. Moreover after the spraying, the coatings need to be baked at high temperature such that the coating process is allowed to proceed to the next spraying process after the coatings get dry. Therefore the conventional coatings consume plenty of time and energy.

On the other hand, there are also industrials that develop pearl-paint UV coatings, which are cured on the outer shell of the electronic products after one spraying process. However, the agglomeration between the UV-resin and the colored power in the colored pigments is poor, rendering the color of the coatings less controllable. In addition, because of the light screening effect of the colored powder, the UV light can not penetrate into the deep part of the coating, which makes it difficult to light cure the coating thoroughly.

### SUMMARY OF THE INVENTION

Therefore, the purpose of the present invention is to provide a light curable colored coating, which doesn't require repeated coating, and can be cured at the room temperature, and thus possess the advantages of energy saving, environmental friendly, low-production cost . . . etc.

The technical methods adopted by the present invention to solve the conventional technical problems disclose a light curable colored coating by which a substrate is coated, comprising a photoinitiator, a UV resin and a UV photosensitive phosphor, wherein the light curable colored coating is formed by mixing and then separating the photoinitiators, the UV resin and the UV photosensitive phosphor, wherein the light curable colored coating is cured after being exposed to curing light.

According to an embodiment of the present invention, the weight percentage of the UV photosensitive phosphor is in a range from 0.5% to 70%.

According to an embodiment of the present invention, it further comprises colored powder.

According to an embodiment of the present invention, the wavelength of the curing light is in a range from 193 nm to 445 nm.

According to an embodiment of the present invention, the UV photosensitive phosphor is excited to radiate light with high-throughput fluorescent quantum and with wavelength larger than 193 nm after absorbing the curing light.

According to an embodiment of the present invention, the UV photosensitive phosphor is formed by mixing an oxide and an atom, an ion or a compound of groups IA, IVB, VB, VIB, IIB, IVA and then sintering the mixture.

According to an embodiment of the present invention, the UV photosensitive phosphor is formed by mixing an oxide and an atom, an ion and a compound of groups VIIB, IIIA, VA, VIIA or lanthanide and then sintering the mixture.

According to an embodiment of the present invention, the UV photosensitive phosphor is formed by reduction after being sintered.

According to an embodiment of the present invention, a material of the substrate is selected from plastics, glasses, porcelain, paper and metal.

According to an embodiment of the present invention, it further comprises an additive selected from one or more from a group comprising filler, heat stabilizer, antioxidant, fungicide, reinforcing agent, hardening agent, cross-linking agent, plasticizer, blowing agent, lubricant, processing aid, flame resisting agent, fireproofing agent, fire retardant, optical brightener, matting agent, color developing agent, antistatic agent and anti-adherents.

Via the technical methods adopted by the present invention, the UV photosensitive phosphor is added to the colored coating provided by the present invention, and after the UV photosensitive phosphor absorbs the energy of the curing light, it will radiate the energy in the form of light, enabling the light to be transmitted into the deep part of the light curable colored coating, enhancing the cross-linking rate and efficaciously accelerating the curing rate of the light curable colored coating.

In addition, as the deep part of the conventional pearl-paint UV coating is hard to be cured, it requires many times of UV-irradiation for light curing the deep part thoroughly, causing the substrates the embrittlement problem from excess UV or excessively high temperature. Accelerating the curing rate in the deep part of the colored coating by adding the UV photosensitive phosphor of the present invention can avoid the embrittlement problem of the substrate caused by excess UV exposure.

Moreover, for the colored coating can be cured instantly after being exposed to the curing light and the reaction can happen at room temperature, there is no need to bake the coating at high temperature, and also no need to spray the coating repeatedly, and hence it efficaciously reduces the production time and cost.

### DETAILED DESCRIPTION OF THE PREFERRED EMBODIMENTS

To further elaborate the technical methods adopted by the present invention to serve the expected purpose and the efficacy of the present invention, the detailed description of the light curable colored coating and the applications thereof in the present invention are described as follows.

The colored coating in the light curable colored coating of the present invention comprises a photoinitiator, a UV resin and a UV photosensitive phosphor

The photoinitiator can absorb the radiant energy, and during the light curing process of the colored coating, the photoinitiator can induce the polymerization function. The photoinitiator is possessed with good thermal stability. For example, the photoinitiator could be P-methoxy phenylacetone (Molecular Formula: C10H12o2), 9-Phenylacridine (Molecular Formula: C19H13N), N-phenylglicine (Molecular Formula: C8H9NO2) . . . etc.

The UV resin produces living free radicals and radical ions after absorbing the curing light, thereby inducing polymerization, crosslink reaction and grafting reaction, making the UV resin transform from liquid state to solid state within few seconds, wherein the phase transition is called “light cure.” For example, the UV resin is an aliphatic PU-acrylate oligomer resin, aliphatic PU-acrylate, Epoxy-acrylate or Novolac Epoxy-acrylate . . . etc.

The UV photosensitive phosphor is formed by mixing an oxide and an atom, an ion or a compound of groups IA, IVB, VB, VIB, VIIB, IIB, IIIA, IVA, VA, VIIA or lanthanide and then sintering the mixture. More specifically, in the sintering process, the UV photosensitive phosphor is formed by mixing an oxide and an atom, an ion or a compound of groups IA, IVB, VB, VIB, VIIB, IIB, IIIA, IVA, VA, VIIA or lanthanide to become a pre-production powder, and then sintering the pre-production powder. In detail, in the sintering process the pre-production powder is disposed in an gas environment filled with non-reactive gas like nitrogen and inert gas, and is sintered at high temperature from 400 to 1250 degree to form the UV photosensitive phosphor structure. Alternatively, the sintered UV photosensitive phosphor can be further disposed in an gas environment filled with reactive gas like hydrogen, oxygen, ammonia, in which a reduction reaction is performed at temperature form 400 to 1200 degree. To go a step further, the UV photosensitive phosphor, which has gone through the sintering process, could further be grinded to have a proper grain size to facilitate the mixing process with other components.

The UV photosensitive phosphor can not only absorb the curing light, but also, after being excited by the curing light, can further radiate light with wavelength larger than 193 nm. In this embodiment, the weight percentage of the UV photosensitive phosphor is in a range from 0.5% to 70%. It means that the weight percentage of the photoinitiator and the UV resin is in a range from 50% to 95.5%. [ 0025 ] Mix and blend the above-mentioned photoinitiator, UV resin and UV photosensitive phosphor, and use the three roller and the homogenizer to separate the mixture to form the colored coating, and thereafter apply the colored coating on a substrate and furthermore expose the substrate to a curing light. More specifically, the curing light has a wavelength in a range from 193 nm to 445 nm. In this embodiment, the curing light is UV light, whose wavelength is in a range from 10 nm to 400 nm. Alternatively, the curing light is NUV, or Near UV, with a wavelength in a range from 300 nm to 400 nm, the H-line with wavelength of 405 nm, the G-line light with wavelength of 436 nm or the ArF light with wavelength of 193 nm. For instance, the coating process could include using a coating machine, a roller coating machine, a flow coating machine, a spray coating machine, a knife coating machine or a printing machine to apply the light curable colored coating of the present invention on a substrate by coating, roller coating, flow coating , spray coating, knife coating and printing. On the other hand, the substrate could be an external shell, an outer surface, a built-in circuit board, an electronic component or an electronic pad of an electronic products, life products, building products, electrical products . . . etc. [ 0026 ] Since the UV photosensitive phosphor is excited to a excited state after absorbing the curing light, and then returns to a ground state after emitting visible light, enabling the light to transmit to the deep part of the light curable colored coating and enhancing the cross-linking rate, the curing rate of the light curable colored coating is thus efficiently accelerated, and therefore the colored coating of the present invention can rapidly being cured on the substrate such as plastics (for example: polyester, polycarbonate, ABS, PMMA and PI), glasses, paper, porcelains and metals . . . etc.

In addition, since the colored coating is easily-cured in such a manner that it is instantly cured after exposing to curing light at room temperature, it is possessed with the advantages of energy saving, time saving, environmental friendly, low production cost . . . etc. Furthermore, since the colored coating is possessed with the advantage of color invariance, the colored coating of the present invention could also be applied to the outer wall of an architectural substrate.

Alternatively, the light curable colored coating further comprises an additive. For example, the additive could comprise the heat stabilizer, antioxidant, fungicide, reinforcing agent, hardening agent, cross-linking agent, plasticizer, blowing agent, lubricant, processing aid, flame resisting agent, fireproofing agent, fire retardant, optical brightener, matting agent, color developing agent, antistatic agent and anti-adherents . . . etc, and thus possess the advantages of stabilizing, reinforcing, hardening, softening, portability, process improving and surface modification . . . etc.

Alternatively, the light curable colored coating further comprises a filler. In general, the fillers are low-priced, and thus adding a proper amount of filler to the light curable colored coating can save the raw material cost. For example, the filler could be carbonates, silicates . . . etc. Preferably, the filler doesn't chemically react with other components of the light curable colored coating.

More specifically speaking, the UV resin is transparent and colorless, transparent and light-yellow, or is shown in any other colors. Therefore, the light curable colored coating can be directly applied to a substrate and show the color of the UV resin. Alternatively, when it is required to adjust the color of the light curable colored coating, the colored powder of various colors can be added to the light curable colored coating to show different colors. In this embodiment, the colored powder is a inorganic pigment possessed of shading function, such as titanium dioxide, iron oxide, chrome yellow, lead molybdate chromate . . . etc. Since the light curable colored coating comprises the light-emittable UV photosensitive phosphor, even though the colored powder is added to it, it can still transmit the light curing light into the deep part of the coating and achieve rapid light-cure effect. Moreover, the UV resin and the colored powder are agglomerated in good quality, and thus the color of the light curable colored coating can be adjusted via the colored powder to meet the needs of various applications. However, the present invention is not limited to this. The colored powder can be organic pigments, such as tetrazo, monoazo, phthalocyanine, fused ring . . . etc. [ 0031 ] The above description should be considered as only the discussion of the preferred embodiments of the present invention. However, a person with ordinary skill in the art may make various modifications to the present invention and those modifications still fall within the spirit and scope defined by the appended claims.

What is claimed is:

1. A light curable colored coating by which a substrate is coated, comprising: a photoinitiator, a UV-resin and a UV photosensitive phosphor, wherein the light curable colored coating is formed by mixing and then separating the photoinitiator, the UV-resin and the UV photosensitive phosphor, wherein the light curable colored coating is cured after being exposed to curing light.

2. The light curable colored coating as claimed in claim 1, wherein the weight percentage of the UV photosensitive phosphor is in a range from 0.5% to 70%.

3. The light curable colored coating as claimed in claim 1, further comprising colored powder.

4. The light curable colored coating as claimed in claim 1, wherein the wavelength of the curing light is in a range from 193 nm to 445 nm.

5. The light curable colored coating as claimed in claim 1, wherein the UV photosensitive phosphor is excited to radiate light with high-throughput fluorescent quantum and with wavelength larger than 193 nm after absorbing the curing light.

6. The light curable colored coating as claimed in claim 1, wherein the UV photosensitive phosphor is formed by mixing an oxide and an atom, an ion or a compound of groups IA, IVB, VB, VIB, IIB, IVA and then sintering the mixture.

7. The light curable colored coating as claimed in claim 1, wherein the UV photosensitive phosphor is formed by mixing an oxide and an atom, an ion and a compound of groups VIIB, IIIA, VA, VIIA or lanthanide and then sintering the mixture.

8. The light curable colored coating as claimed in claim 6, wherein the UV photosensitive phosphor is formed by reduction after being sintered.

9. The light curable colored coating as claimed in claim 7, wherein the UV photosensitive phosphor is formed by reduction after being sintered.

10. The light curable colored coating as claimed in claim 1, wherein a material of the substrate is selected from plastics, glasses, porcelain, paper and metal.

11. The light curable colored coating as claimed in claim 1, further comprising an additive selected from one or more from a group comprising filler, heat stabilizer, antioxidant, fungicide, reinforcing agent, hardening agent, cross-linking agent, plasticizer, blowing agent, lubricant, processing aid, flame resisting agent, fireproofing agent, fire retardant, optical brightener, matting agent, color developing agent, antistatic agent and anti-adherents.
